(19) United States
(12) Patent Application Publication
(10) Pub. No.: US 2024/0087867 A1
(43) Pub. Date: Mar. 14, 2024

(54) METHOD AND DEVICE FOR SAMPLE INTRODUCTION FOR MASS SPECTROMETRY

(71) Applicant: JP Scientific Limited, Waterloo (CA)

(72) Inventors: Janusz Boleslaw PAWLISZYN, Waterloo (CA); Wei ZHOU, Waterloo (CA)

(21) Appl. No.: 18/235,469

(22) Filed: Aug. 18, 2023

Related U.S. Application Data
(60) Provisional application No. 63/405,184, filed on Sep. 9, 2022.

(51) Int. Cl. H01J 49/04

(52) U.S. Cl. CPC H01J 49/0459

(57) ABSTRACT

The present disclosure provides a device for generating ionized molecules of interest for analysis in a mass spectrometer. The molecules of interest are desorbed from the device into a desorption solvent. The device includes: a solid substrate having a spray-ionization end and a holding end, the substrate being sized and configured to hold the solvent at the spray-ionization end; and a fluid barrier configured to reduce movement of at least some of the solvent from the spray-ionization end towards the holding end. Methods for analyzing molecules in or from a sample are also provided.

### CROSS-REFERENCE TO RELATED APPLICATIONS

This application claims the benefit of priority of U.S. Provisional Patent Application No. 63/405,184 filed Sep. 9, 2022, which is hereby incorporated by reference.

### FIELD

The present disclosure generally relates to methods, devices, and systems for one or more of collection, enrichment, and analysis of molecules of interest in mass spectrometry.

### BACKGROUND

The following paragraphs are not an admission that anything discussed in them is prior art or part of the knowledge of persons skilled in the art.

Mass spectrometry (MS) has emerged as a powerful and popular tool in fields such as physics, chemistry, and biology due to its many advantages, including high sensitivity, selectivity, fast scanning speeds, and strong molecular structure elucidation. The coupling of ambient ionization and MS (AMS) eliminates the need for time-consuming sample preparation and chromatography separation processes, which simplifies the protocols and decreases the turnaround time. As such, AMS has garnered considerable attention among researchers, especially in fields such as clinical, forensic, and antidoping analysis, where rapid analysis is highly desirable. The subsequent introduction of desorption electrospray ionization (DESI) and direct analysis in real time (DART) further facilitated the development of numerous new ambient ionization methods.

Substrate-based electrospray ionization (ESI) is an ambient MS technique that uses a solid substrate as the holder for aqueous or solid samples and the spray emitter. Different types of substrates, such as paper, wooden tip, plastic, or metal needle, have been used in various applications. Of these substrates, paper spray is the most popular, thanks to its commercialization and implementation in many research areas.

### INTRODUCTION

The following introduction is intended to introduce the reader to this specification but not to define any invention. One or more inventions may reside in a combination or sub-combination of the apparatus elements or method steps described below or in other parts of this document. The inventors do not waive or disclaim their rights to any invention or inventions disclosed in this specification merely by not describing such other invention or inventions in the claims.

In substrate-based electrospray ionization (ESI) techniques, the use of negative ESI mode often results in corona discharge, high background noise, and/or unstable spray. In particular, the presence of salts can cause obvious ionization inhibition in negative mode, especially in the analysis of complex biological samples, such as blood and urine. To date, several strategies for improving performance in negative ionization mode have been reported, including coating the spray paper with a two-dimensional (2D) fluorinated boron nitride nanosheet or 1-[3-(trimethoxysilyl)propyl]urea; mixing additives into the desorption solvents; or using sheath gas to suppress the discharge phenomenon. Unfortunately, even with these tedious modifications, the overall relative standard deviation (RSD) remains high, especially for the analysis of complex biological samples.

Coated blade spray (CBS) is a technique that combines sample preparation and ambient MS into one device. The CBS device may include a conductive stainless-steel blade with a sharp tip that is coated with a biocompatible coating material, such as a thin polymeric material that includes sorbent particles. The coating's high specific surface area and use of matrix-compatible sorbents enables the rapid extraction of target compounds from the sample matrix via solid phase microextraction (SPME). After extraction, the device may be washed with water to remove any matrix components that could interfere with the determination, followed by the application of several microliters of desorption/ionization solution to the blade to desorb the analytes. Finally, high voltage may be applied to the metal blade to induce ESI and enable MS analysis.

Unlike other substrate-based ambient MS techniques, including paper spray, sampling in CBS is based on the distribution of the target compounds between the matrix and the biocompatible coating material, which has a porous structure that prevents the extraction of larger molecules like cells and proteins. Additionally, after sampling complex matrices (e.g., blood, urine, or tissue), the brief washing step also helps with the removal of salts, which induce corona discharge. Furthermore, more recent CBS blade designs feature top and bottom faces of the blade narrowing to a point, such as a meniscus-shaped blade tip, which can decrease the onset voltage for ESI spray. From a side view, a meniscus-shaped blade tip refers to the top face of the blade curving down to the bottom face in the general shape of a convex meniscus. From a side view, a flat-shaped blade tip refers to a wedge-shaped tip with top and bottom faces remaining substantially parallel.

Using the above strategies, no corona discharge was observed when an ESI voltage of −3.8 kV was applied to the device at an optimum distance from the MS inlet. However, the MS signal in negative mode was still not stable compared to the signal in positive mode. In a further attempt to reduce the method's RSD % in negative mode, the metal tip was carefully wetted with solvents and the bubbles were removed from the desorption solution during application to the blade. These steps resulted in a total RSD % of about 20-30% (including sample preparation and detection) for the analysis of four drugs of abuse in saliva samples, which is still relatively high, especially considering the fact that the whole operation process was still tedious and difficult to automate.

The authors of the present disclosure determined that using gravity to push the ionization solvent towards the ionization tip and preventing or reducing the movement of ionization solvent away from the ionization tip reduced the overall RSD % of the sample preparation, ionization, and MS detection of several drugs of abuse. In some examples, the overall RSD % was reduced to less than 10% in negative mode, without calculation using an internal standard. The authors of the present disclosure determined that this benefit could be accomplished by incorporating a barrier close enough to the ionization tip that the solvent being added between the tip and the barrier would be prevented from migrating backwards. Without wishing to be bound by theory, the authors of the present disclosure believe that preventing or reducing the movement of ionization solvent away from the ionization tip encourages the flow of ionization solvent in the direction of the ionization tip due to gravity and/or surface tension effects on the liquid. The barrier could be integral with the substrate, or the barrier could be provided by a separate component, such as by a holder configured to hold the substrate.

Without wishing to be bound by theory, the authors of the present disclosure believe that the improved RSD % resulted from the barrier providing more stable liquid flow during ESI. In coated blade spray applications, the improved RSD % may result from the barrier preventing loss of desorption solvent to an uncoated area of the blade.

In one aspect, the present disclosure provides a device for generating ionized molecules of interest for analysis in a mass spectrometer, where the molecules of interest are desorbed from the device into a desorption solvent. The device includes: a solid substrate having a spray-ionization end and a holding end, the substrate sized and configured to hold the solvent at the spray-ionization end; and a fluid barrier configured to reduce movement of at least some of the solvent from the spray-ionization end towards the holding end.

In another aspect, the present disclosure provides a solid substrate for generating ionized molecules of interest for analysis in a mass spectrometer. The substrate is configured to engage with a substrate holder. The substrate includes: a spray-ionization end and a holding end, where the substrate is sized and configured to hold solvent at the spray-ionization end. The substrate holder is configured to engage the holding end of the substrate and form a fluid barrier configured to reduce movement of at least some of the solvent from the spray-ionization end towards the holding end.

In yet another aspect, the present disclosure provides a method for analyzing molecules previously extracted from a sample and adsorbed onto a solid substrate, where the substrate includes a spray-ionization end, a holding end, and a fluid barrier between the spray-ionization end and the holding end, where the extracted molecules are adsorbed on an extraction portion of the substrate between the fluid barrier and the spray-ionization end. The fluid barrier is configured to reduce movement of at least some of a desorption solvent from the spray-ionization end to the holding end. The method includes: holding the substrate in a substantially horizontal orientation; applying the desorption solvent to the substrate; desorbing molecules from the substrate; ionizing the desorbed molecules using an ionization source to expel ionized molecules from the spray-ionization end of the substrate; and analyzing the formed ions by mass spectrometry.

In still another aspect, the present disclosure provides a method for analyzing molecules previously extracted from a sample onto a device as described herein. The method includes: holding the substrate in a substantially horizontal orientation; applying a desorption solvent to the device; desorbing molecules from the device; ionizing the desorbed molecules using an ionization source to expel ionized molecules from the spray-ionization end of the substrate; and analyzing the formed ions by mass spectrometry.

In yet another aspect, the present disclosure provides a method for analyzing molecules in a sample. The method includes: holding a solid substrate in a substantially horizontal orientation. The substrate includes a spray-ionization end, a holding end, a fluid barrier between the spray-ionization end and the holding end, and a sorption portion between the fluid barrier and the spray-ionization end. The method includes applying a sample solution to the sorption portion of the substrate; removing the sample solution from the substrate; and performing the desorption and analysis method as described herein.

In still a further aspect, the present disclosure provides a method for analyzing molecules in a sample. The method includes: extracting molecules of interest from a sample onto a solid substrate, such as through solid phase microextraction (SPME), where the substrate includes a spray-ionization end, a holding end, and a sorption portion; holding the substrate with a substrate holder configured to engage the holding end of the substrate, where holding the substrate with the substrate holder provides a fluid barrier between the spray-ionization end and the holding end, and where the substrate is held in a substantially horizontal orientation; applying a desorption solvent to the device; desorbing molecules from the device; ionizing the desorbed molecules using an ionization source to expel ionized molecules from the spray-ionization end of the substrate; and analyzing the formed ions by mass spectrometry.

### BRIEF DESCRIPTION OF DRAWINGS

Examples according to the present disclosure will now be described, by way of example only, with reference to the attached Figures.

FIG. 1 illustrates an exemplary device according to the present disclosure.

FIG. 2 illustrates another exemplary device according to the present disclosure.

FIG. 3 illustrates a further exemplary device according to the present disclosure.

FIG. 4 illustrates yet another exemplary device according to the present disclosure.

FIG. 5 is an illustration of a typical spectrogram for a method according to the present disclosure.

FIG. 6 shows video screenshots of ESI spray with devices according to the present disclosure and comparative devices. Taylor cone (first three columns) and solvent movement (the last two columns) on the blade during the CBS process with the time (two enlarged views of the solvent on the blade are inserted).

FIGS. 7A to 7E illustrate spectrograms for methods according to the present disclosure using different volumes of desorption solution.

FIG. 8 illustrates the applied voltage for a method according to the present disclosure.

FIGS. 9A to 9D, 10A and 10B illustrate the calibration curves of dexamethasone, prednisolone and budesonide in urine, with and without calibration using an internal standard, in negative ionization by automated and high-throughput SPME.

FIGS. 11A to 11C illustrate the chromatograms for the three drugs at the LOQ concentration level.

FIG. 12 illustrates the CBS-MS chromatograms of prednisolone-¹³C₃ in 42 urine samples.

FIGS. 13 to 19 illustrate the calibration curve of drugs of abuse, with and without the calibration using an internal standard, in positive ionization mode.

### DETAILED DESCRIPTION

In one aspect, the present disclosure provides a device for generating ionized molecules of interest for analysis in a mass spectrometer. The molecules of interest are desorbed from the device into a desorption solvent. The device includes: a solid substrate having a spray-ionization end and a holding end, the substrate being sized and configured to hold the solvent at the spray-ionization end; and a fluid barrier configured to reduce movement of at least some of the solvent from the spray-ionization end towards the holding end.

In the context the present disclosure, the term “solid substrate” should be understood to refer to a conductive substrate, such as a conductive substrate that may be used for a spray-ionization device.

The barrier may be integral with the substrate. Alternatively, the device may further include a substrate holder configured to engage the holding end of the substrate, and where the substrate holder provides the barrier.

Providing a fluid barrier may include positioning the substrate holder to engage a face of the substrate, thereby creating the fluid barrier. The substrate holder may include a feature that forms the barrier, and the barrier may abut the substrate when the substrate holder engages the holding end of the substrate.

The fluid barrier may be positioned between the spray-ionization end and the holding end a sufficient distance away from the ionization tip to prevent or reduce the movement of ionization solvent away from the ionization tip. For example, the substrate and the barrier may be configured and positioned to hold at least 5 μL of the solvent, such as from about 5 μL to about 15 μL of the solvent, between the spray-ionization end and the barrier; the barrier may extend at least about 0.5 mm above the surface of the substrate; and/or the distance from the spray-ionization end to the barrier may be from about 4 mm to about 10 mm.

In the context of the present disclosure, the term “spray-ionization end” refers to the portion of the substrate that receives the desorption solvent and that holds the desorption solvent before it is sprayed from the ionization tip. The term “ionization tip” refers to the portion of the substrate that generates the ionized molecules in a spray-ionization. The ionization tip is a part of the spray-ionization end. The distance from the spray-ionization end to the barrier is measured starting from the ionization tip.

The barrier may extend from one side edge of the substrate to an opposite side edge, for example dividing the substrate into a holding portion and a spray-ionization portion. The barrier may be configured to reduce movement of at least some of the solvent towards edges that are not for spray ionization, such as side edges. The substrate may, for example, be sufficiently curved in a width-wise manner to direct the solvent away from the edges of the substrate, such as along the longitudinal axis of the substrate. A cross-sectional view of the substrate may, for example, show a curve that is from about 15° to about 60°, such as about 30°. The substrate may be at least a two-sided substrate and the device may include a fluid barrier on each side. The fluid barrier on the additional sides may be provided by the substrate holder.

The device may be configured to desorb the molecules of interest into the desorption solvent and generate the ionized molecules while the surface of the substrate is substantially horizontal. In the context of the present disclosure, the term “substantially horizontal” should be understood to mean that the surface is positioned in an orientation where a desorption solvent placed on the surface of the substrate does not move due only to gravity. In some examples, a substantially horizontal orientation may be an orientation with an absolute pitch angle of less than 15°, such as less than 10°, less than 5° or about 0°.

The barrier may be surface-deactivated. In the context of the present disclosure, the expression “surface-deactivated” refers to a surface that has been treated to reduce adsorption of macromolecules and organic compounds. For example, a surface may be covered with a layer of material, such as with a layer of polyacrylonitrile (PAN), to reduce adsorption of macromolecules and organic compounds. Surface deactivation is discussed in US20210156767A1, which is incorporated herein by reference.

In devices according to the present disclosure, the substrate may be substantially flat or may include an indentation or curve in the substrate to direct the desorption liquid along the longitudinal axis of the substrate; the substrate may be at least one of a metal, a metal alloy, and a polymer, preferably previously etched stainless-steel; the substrate may be surface-deactivated; the substrate may be a combination of different materials, such as a carbon mesh thin film layered on a conductive base structure; the spray-ionization end may include a tip having a substantially triangular shape and being defined by at least two edges that meet at an angle from about 8 degrees to about 90 degrees, or may include a meniscus-shaped tip; the substrate may have an average thickness that is from about 0.01 mm to about 2 mm; the substrate may have a length from about 1 cm to about 10 cm; the substrate may have a width from about 0.1 to about 5 mm; the device may include an extractive phase coating, such as a solid phase microextraction (SPME) coating, on at least a portion of the surface between the spray-ionization end and the barrier, and optionally may include a sealing layer between the extractive phase coating and the substrate, preferably wherein the sealing layer lacks any extractive phase material; the substrate may have a non-uniform thickness such that the spray-ionization end has a smaller thickness relative to the rest of substrate, the non-uniform thickness creating a slope to lead by gravity the solvent containing the molecules of interest towards the spray-ionization end; the desorption solvent may include at least one of methanol, acetonitrile and water; and/or the device may be configured to generate spray in a negative ionization mode. Different shaped tips, such as tapered, blunt tapered, sharp, 30° beveled, 35° beveled, 45° beveled, are disclosed my E. J. Maxwell in Anal. Chem. 2010, 82, 20, 8377-838, which is incorporated herein by reference.

Substrates suitable for generating ionized molecules of interest for analysis in a mass spectrometer, but lacking a fluid barrier configured to reduce movement of at least some of the solvent from the spray-ionization end towards the holding end, are disclosed in US Patent Publication Nos. US20150318160A1 and US20210257204A1. SPME coatings that may be used on substrates according to the present disclosure are disclosed in US Patent Publication No. US20210156767A1. The disclosures are hereby incorporated by reference in their entirety.

In another aspect, the present disclosure provides a method for analyzing molecules previously extracted from a sample and adsorbed onto a solid substrate. The substrate includes a spray-ionization end, a holding end, and a fluid barrier between the spray-ionization end and the holding end, where the extracted molecules are adsorbed on an extraction portion of the substrate between the fluid barrier and the spray-ionization end. The method includes: holding the substrate in a substantially horizontal orientation; applying a desorption solvent to the substrate; desorbing molecules from the substrate; ionizing the desorbed molecules using an ionization source to expel ionized molecules from the spray-ionization end of the substrate; and analyzing the formed ions by mass spectrometry. In this method, the fluid barrier is configured to reduce movement of at least some of the desorption solvent from the spray-ionization end to the holding end.

In various examples, methods according to the present disclosure may include applying from about 5 μL to about 15 μL of the desorption solvent to the substrate.

In the context of the present disclosure, a pitch angle should be understood to refer to the angle of the substrate, in relation to horizontal, from the holding end to the spray-ionization end. A negative pitch angle reflects the spray-ionization end being lower than the holding end. A positive pitch angle reflects the spray-ionization end being higher than the holding end. An absolute pitch angle refers to the absolute magnitude of the pitch angle, irrespective of the positive or negative value. For example, a device with a negative 5° pitch angle has the same absolute pitch angle as a device with a positive 5° pitch angle.

The barrier may be integral with the substrate. Alternatively, the method may include holding the substrate with a substrate holder where holding the substrate with the substrate holder provides the fluid barrier. The substrate holder may hold the holding end of the substrate while the substrate is used to adsorb molecules of interest from a sample. Alternatively, the substrate may be used to adsorb molecules of interest from a sample without being held by the substrate holder. In such a method, the method includes subsequently using the substrate holder to engage the holding end.

The ionization may be negative ionization and/or the mass spectrometry may be electrospray ionization.

The extraction portion of the substrate may be substantially flat and the method may include holding the substrate in an orientation with the extraction portion having an absolute bank angle of less than 15°, such as less than 10°, less than 5° or about 0°. In the context of the present disclosure, a bank angle should be understood to refer to the angle of the substrate, in relation to horizontal, around an axis extending from the holding end to the spray-ionization end. A negative bank angle reflects the left side of the substrate being lower than the right side of the substrate. A positive bank angle reflects the left side of the substrate being higher than the right side of the substrate. An absolute bank angle refers to the absolute magnitude of the bank angle, irrespective of the positive or negative value. For example, a device with a negative 5° bank angle has the same absolute bank angle as a device with a positive 5° bank angle.

The extraction portion may include an extraction phase coating between the fluid barrier and the spray-ionization end, the molecules being adsorbed on the extraction phase coating.

In some examples, the substrate includes at least two sides, where the substrate also includes a fluid barrier on the second side between the spray-ionization end and the holding end, additional extracted molecules are adsorbed on a second extraction portion of the substrate between the fluid barrier and the spray-ionization end, and the method further includes analyzing molecules previously extracted from a sample and adsorbed onto the second side of the solid substrate. For example, the method may include: removing the desorption solvent from the solid substrate, repositioning the solid substrate to present the second side of the substrate in a substantially horizontal orientation; applying a desorption solvent to the second side of the solid substrate; desorbing molecules from the second side of the solid substrate; ionizing the desorbed molecules using an ionization source to expel ionized molecules from the spray-ionization end of the solid substrate; and analyzing the formed ions by mass spectrometry. Analyzing the second side of the substrate provides a second data point from the same sample.

The second extraction portion may be substantially flat and the method may include holding the substrate in an orientation with the second extraction portion having an absolute bank angle of less than 15°, such as less than 10°, less than 5° or about 0°.

In another aspect, the present disclosure provides a solid substrate for generating ionized molecules of interest for analysis in a mass spectrometer. The substrate is configured to engage with a substrate holder. The substrate includes: a spray-ionization end and a holding end, where the substrate is sized and configured to hold a spray-ionization amount of solvent at the spray-ionization end. The substrate holder is configured to engage the holding end of the substrate and to form a fluid barrier configured to reduce movement of at least some of the solvent from the spray-ionization end towards the holding end.

In yet another aspect, the present disclosure provides a method for analyzing molecules previously extracted from a sample onto a device as described herein. The method includes: holding the substrate in a substantially horizontal orientation; applying a desorption solvent to device; desorbing molecules from the device; ionizing the desorbed molecules using an ionization source to expel ionized molecules from the spray-ionization end of the substrate; and analyzing the formed ions by mass spectrometry.

In still another aspect, the present disclosure provides a method for analyzing molecules in a sample. The method includes: holding a solid substrate in a substantially horizontal orientation, where the substrate includes a spray-ionization end, a holding end, a fluid barrier between the spray-ionization end and the holding end, and a sorption portion between the fluid barrier and the spray-ionization end; applying a sample solution to the sorption portion of the substrate; removing the sample solution from the substrate; and performing the desorption and analysis method as described herein.

In yet another aspect, the present disclosure provides a method for analyzing molecules in a sample. The method includes: extracting molecules of interest from a sample onto a solid substrate, such as through solid phase microextraction (SPME), where the substrate includes a spray-ionization end, a holding end, and a sorption portion; holding the substrate with a substrate holder configured to engage the holding end of the substrate, where holding the substrate with the substrate holder provides a fluid barrier between the spray-ionization end and the holding end, where the substrate is held in a substantially horizontal orientation; applying a desorption solvent to device; desorbing molecules from the device; ionizing the desorbed molecules using an ionization source to expel ionized molecules from the spray-ionization end of the substrate; and analyzing the formed ions by mass spectrometry.

In methods and devices according to the present disclosure, the substrate may be held in a manner that results in the fluid barrier being provided in a location that exposes less than all of the sorption portion. For example, if the sorption portion extended from the spray-ionization end to three quarters of the way up the substrate, the substrate would have 75% of its surface area be the sorption portion and 25% of its surface area be a non-sorption portion. The substrate holder could be positioned to create a fluid barrier halfway between the spray-ionization end and the distal end of the substrate. Positioning the fluid barrier at that location would result in the substrate having 50% of its surface area be exposed sorption portion, having 25% of its surface area be unexposed sorption portion, and having 25% of its surface area be a non-sorption portion.

In the context of the present disclosure, the term “unexposed sorption portion” should be understood to refer to an area of the substrate that would not be exposed to a desorption solvent that was added to the spray-ionization end. An unexposed sorption portion may be covered by the substrate holder. Alternatively, an unexposed sorption portion may be uncovered but the fluid barrier may be sized and shaped to prevent desorption solvent from travelling from the spray-ionization end past the fluid barrier.

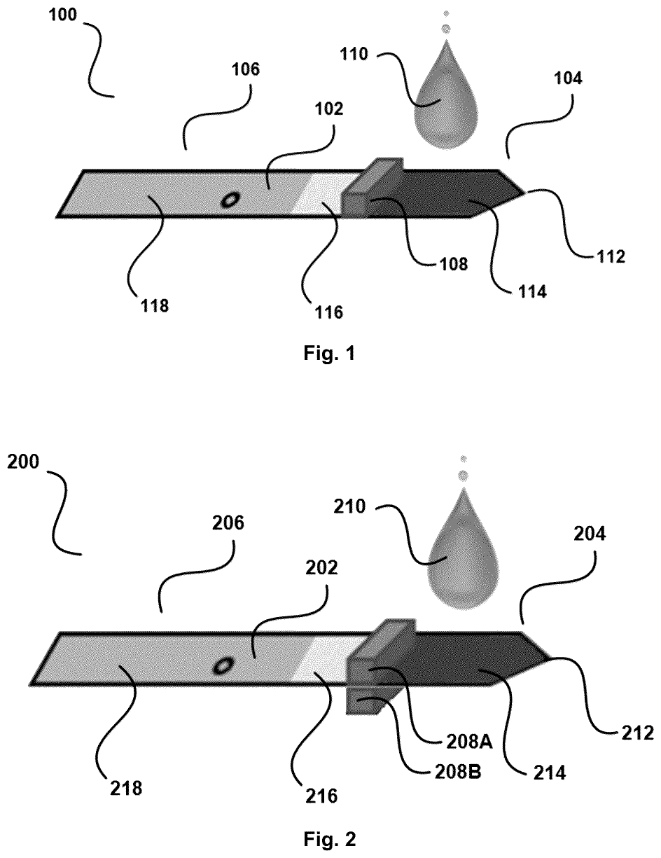

One particular example of a device according to the present disclosure is illustrated in FIG. 1. The device (100) includes a substrate (102) with a spray-ionization end (104) and a holding end (106). The device (100) also includes a fluid barrier (108). The fluid barrier (108) is sized and shaped to reduce movement of at least some of desorption solvent (110) from the spray-ionization end towards the holding end when the solvent (110) is added to the spray-ionization end (104). The spray-ionization end (104) includes a substantially triangular shaped tip (112). The substrate (102) includes an SPME coating layer (114) between the barrier (108) and the tip (112), as well an undercoating layer (116) on the other side of the barrier (108). The substrate (102) also includes a non-sorptive portion (118). The undercoating layer (116) may be a layer of polyacrylonitrile (PAN) that is between the substrate surface and the SPME coating layer. The SPME coating layer may include a mixture of PAN and SPME microparticles.

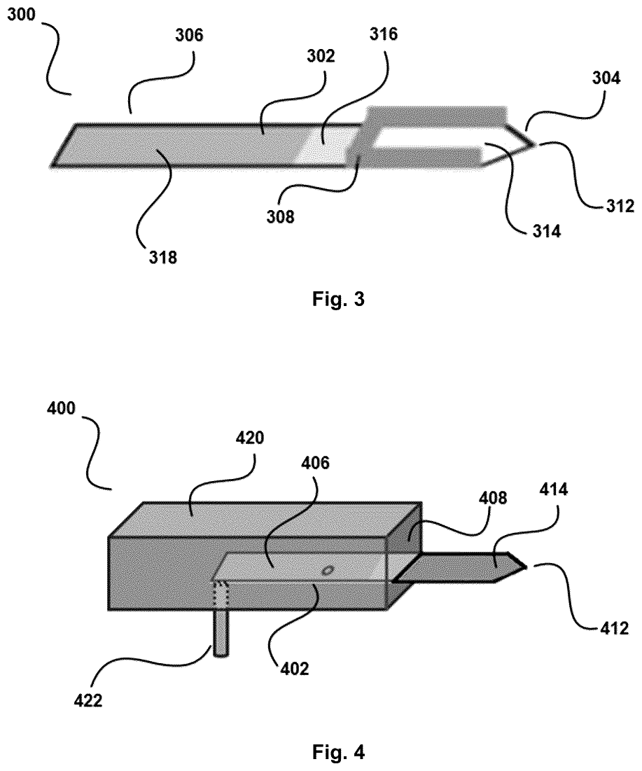

Other examples of devices according to the present disclosure are illustrated in FIGS. 2 to 4. Many of the features of the device illustrated in these figures are similar to those shown and described above with reference to FIG. 1 and are not described again in detail to avoid obscuring the description. Where similar features are described with reference to FIGS. 2 to 4, similar reference numerals are utilized, raised by hundreds.

Device (200) includes a double sided substrate (202) with a first fluid barrier (208A) on one side of the substrate (202), and a second fluid barrier (208B) on the opposite side of the substrate (202). The device (200) may be used in a method where molecules of interest are desorbed from the first side using a first portion of desorption solvent and analyzed, the device is flipped over, and molecules of interest are desorbed from the second side using a second portion of desorption solvent and analyzed.

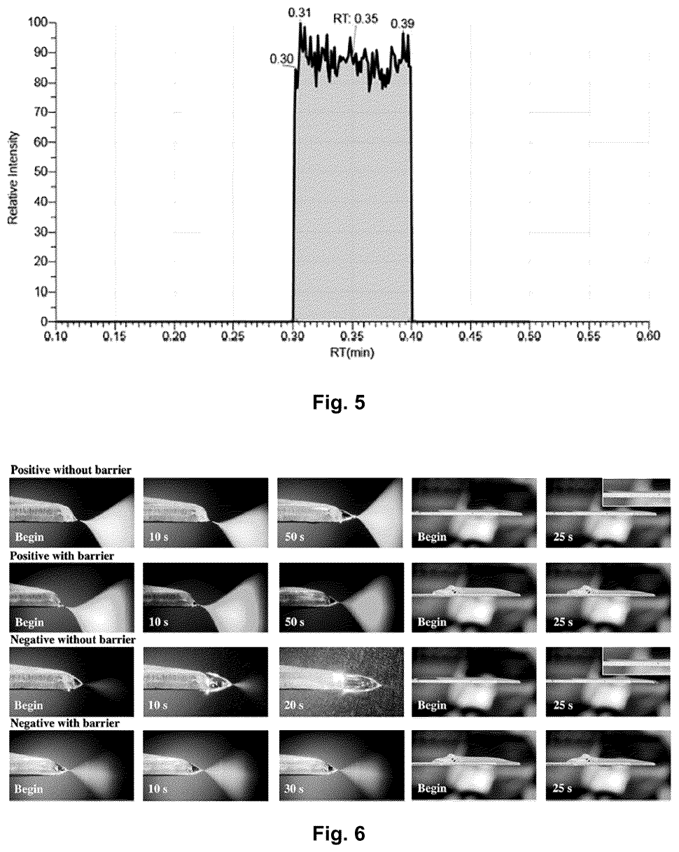

In some examples, the devices illustrated in FIGS. 1 and 2 may include side barriers. This is illustrated in FIG. 3 with regard to device (100) though it should be understood that the device illustrated in FIG. 2 may similarly include barriers that extend around the sides of the substrate.

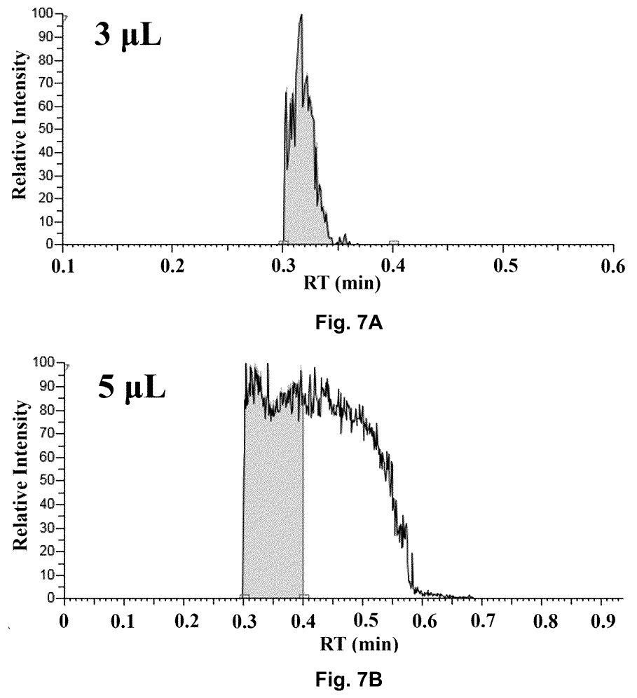

Another example of a device according to the present disclosure is illustrated in FIG. 4. The device (400) includes a substrate holder (420) configured to engage the holding end (406) of the substrate (402). FIG. 4 provides a cut-away view of the device. The substrate holder (420) provides a barrier (408) that abuts the substrate (402). The substrate (402) includes an SPME coating layer (414) between the barrier (408) and the tip (412). FIG. 4A does not illustrate the undercoating layer (416) or the non-sorptive portion (418) since those are covered by the substrate holder (420). The device illustrated in FIG. 4 also includes an electrically conductive connector (422) that allows electricity to be provided to the substrate (402) so that the desorbed molecules can be spray-ionized.

It should be understood that features illustrated in one exemplary device may be incorporated into other exemplary devices. For example, the side barriers illustrated in FIG. 3 may be incorporated into the device illustrated in FIG. 4, where the side barriers are integral with the substrate and the barrier (408) is provided by the substrate holder (420). A device containing both the side barriers (308) illustrated in FIG. 3 and the holder (420) illustrated in FIG. 4 may also be useful when sampling a small amount of fluid (for example, a drop of blood) as it may help reduce or prevent accidental leakage of fluid around the edge to other side of the blade during sampling. A holder providing side barriers could be a removable part to which the substrate fits. The corresponding sampling device could be used remotely on-site, and/or for introducing the extracted components to the mass spectrometry instrument.

### EXAMPLES

In the following examples, devices according to FIG. 1 was used. In the devices, the substrate was a stainless-steel blade, about 10 μm thick, about 2.5 mm wide, and about 1 cm long. The substrate had a PAN undercoating layer, and an outer solid-phase microextraction (SPME) coating. The SPME coating included PAN and hydrophilic-lipophilic balance (HLB) particles microspheres in the range of 100 nm-200 μm. The devices may be referred to as coated blade spray (CBS) blades, or CBS-without-barrier blades. The CBS blades, without a fluid barrier, were obtained from Restek Corporation (Bellefonte, PA).

The CBS blades obtained from Restek were modified to add a fluid barrier 8 mm from the spray tip. The barriers were fabricated by melting a polypropylene pipette tip with a flame and allowing the drops to fall onto the blade 8 mm from the spray tip. The resulting barriers were about 1.5 mm tall, about 4.4 mm long, and spreading across the 2.5 mm width of the blade. The barrier was positioned to extend from one edge to the opposite edge, as illustrated in FIG. 1. The modified CBS blades may be referred to as “CBS-with-barrier” blades.

Chemicals and Materials. LC-MS-grade methanol (MeOH), acetonitrile (ACN), and isopropanol (IPA) were purchased from Fisher Scientific (Hampton, NJ). Formic acid (FA), ammonium formate (NH₄HCOO), ammonium fluoride (NH₄F), and the PBS tablets used to prepare the PBS solution (pH 7.4) were obtained from Sigma Aldrich (Oakville, ON, Canada). The standards and internal standards (ISs), including amphetamine, atenolol, buprenorphine, carbamazepine, clenbuterol, cocaine, codeine, diazepam, fentanyl, lorazepam, morphine, nordiazepam, propranolol, strychnine, dexamethasone, prednisolone, budesonide, amphetamine-do, metoprolol, buprenorphine-do, carbamazepine-d₁₀, clenbuterol-d₉, cocaine-d₃, codeine-d₃, diazepam-d₅, fentanyl-d₅, lorazepam-d₄, morphine-d₃, nordiazepam-d₅, propranolol-d₇, brucine, and prednisolone-¹³C₃(used as an IS for budesonide, dexamethasone, and prednisolone) were purchased from Cerilliant (Round Rock, TX). All standards were dissolved in methanol or CAN at a concentration of 1 mg/mL, all internal standards were dissolved at a concentration of 0.1 mg/mL. For the quantitative analysis, the internal standard concentration was 100 ng/mL in negative mode and 5 ng/mL in positive mode. Human urine was collected from a healthy volunteer who had not taken any of the targeted drugs. Finally, human plasma (pooled gender) was purchased from BioIVT (Hicksville, NY), and CBS blades with a PAN undercoating layer and an HLB outer-coating layer (length: 1 cm; thickness: 10 μm) were obtained from Restek Corporation (Bellefonte, PA).

Instruments and Devices. The TSQ Quantiva mass spectrometer used for detection was obtained from Thermo Scientific (San Jose, CA), and the CBS-MS interface, which consisted of an x-y-z stage and a blade holder, was constructed by the University of Waterloo Machine Shop. The blade was inserted into the holder, where a high voltage was applied to it via a conductive stainless-steel rod. The position of the CBS blade could be easily adjusted by moving the x-y-z stage. In the optimum position, the blade was parallel with the inlet of the MS, which was situated 12 mm from the spray tip. After optimization, an ESI voltage of 5 kV was selected for positive mode, and a voltage of −3.8 kV was selected for negative mode. Additionally, a spray time of 6 s was used without a specific description, and a dwell time of 10 ms was employed for each MRM transition. The MS detection parameters for all target compounds and their internal standards are shown in Table 1, where “+” refers to positive mode detection and refers to negative mode detection. A Concept-96 system, which was modified to create a high-throughput and automated SPME extraction process as described by N. Reyes-Garcés et al. in Journal of Chromatography A, vol. 1374, 2014, pp 40-49, was purchased from PAS Technology (Magdala, Germany). The holder was fabricated by the University of Waterloo Science Technical Services and was capable of holding 96 CBS blades and being used with a 2 mL 96-well plate. The barrier on the CBS blade was fabricated by melting a polypropylene pipette tip with a flame and allowing the drops to fall onto the blade 8 mm from the spray tip. To observe the ESI spray, an offline ESI device was built using a microscope camera and a laser to enable simple and easy operation, as described by Hu, W. et al. in ACS Applied Bio Materials, 2021, 4(8), pp6236-6243.

TABLE 1

| | | | | | Product | Collision | RF |
|---|---|---|---|---|---|---|---|
| | | | Log | Precursor | Ion | Energy | Lens |
| Compounds | Internal Standard | Mode | P | Ion (m/z) | (m/z) | (V) | (V) |
| Amphetamine | Amphetamine-d₅ | + | 1.8 | 136.2 | 91 | 19 | 30 |
| Atenolol | Metoprolol | + | 0.2 | 267.2 | 145 | 27 | 62 |
| Buprenorphine | Buprenorphine-d₅ | + | 4.5 | 468.3 | 396.1 | 40 | 96 |
| Carbamazepine | Carbamazepine-d₁₀ | + | 2.8 | 237.41 | 194.1 | 20 | 83 |
| Clenbuterol | Clenbuterol-d₉ | + | 2.3 | 277.2 | 203.07 | 17 | 48 |
| Cocaine | Cocaine-d₃ | + | 2.0 | 304.24 | 182.3 | 22 | 61 |
| Codeine | Codeine-d₃ | + | 1.2 | 300.25 | 165 | 42 | 75 |
| Diazepam | Diazepam-d₅ | + | 2.6 | 285.2 | 193 | 33 | 81 |
| Fentanyl | Fentanyl-d₅ | + | 4.1 | 337.3 | 188.08 | 23 | 69 |
| Morphine | Morphine-d₃ | + | 0.9 | 286.25 | 165.08 | 41 | 78 |
| Nordiazepam | Nordiazepam-d₅ | + | 2.9 | 271.2 | 140.07 | 28 | 58 |
| Propranolol | Propranolol-d₇ | + | 3.0 | 260.29 | 116.13 | 19 | 60 |
| Strychnine | Brucine | + | 1.9 | 335.29 | 184.13 | 38 | 92 |
| Budesonide | Prednisolone-³C₁₃ | − | 2.2 | 475.3 | 357.22 | 15 | 61 |
| Dexamethasone | Prednisolone-³C₁₃ | − | 1.8 | 437.29 | 361.29 | 18 | 53 |
| Prednisolone | Prednisolone-³C₁₃ | − | 1.6 | 405.25 | 295.08 | 31 | 30 |

Analytical Protocols. Samples with volumes exceeding 300 μL were processed using the automated Concept-96 device. The SPME process included the following three general steps: (1) preconditioning, which involved placing the blades in a MeOH/water (50:50, v/v) solution and vortexing them for 15 min at 1500 rpm; (2) extraction, which involved immersing the blades in the sample solutions for 10 min with agitation at 1500 rpm; and (3) washing the blades with water for 5 s following the extraction step to reduce or eliminate the nonspecific attachment of salts or other impurities from the sample matrix. The above-described experiment can be automated and configured for high-throughput (such as up to 96 samples at once) using the Concept-96 system.

For the analysis of samples with volumes of less than 20 μL, on-blade spot analysis can be used. These analyses also included the following three general steps: (1) preconditioning, which was conducted using the same method described above; (2) extraction, which included applying the sample to the coating of the blade and performing a 10 min static extraction; (3) washing, which involved cleaning the sample spot on the blade with a Kimwipe, followed by washing in a vial with 1.5 mL of water for 5 s with vortexing. The first step was performed using the Concept-96 autosampler using all 96 blades, while the latter two were conducted manually. After both SPME procedures, the blade was inserted into the holder of the CBS interface and several microliters of desorption solution were applied to it. After desorbing for several seconds, a high voltage was applied on the blade and the MS was used to record the signal for a predetermined time period. 8 μL of desorption solution was used for desorption and ionization. According to our previous study, the best desorption and ionization solution in positive ionization mode is MeOH/water 95:5+0.1% FA and in negative ionization mode is MeOH/Water 95:5+2.5 mM NH₄F+2.5 mM NH₄HCOO.

Increasing Ionization Stability in Negative Mode. Substrate-based electrospray ionization methods often encounter the problem of unstable spray in negative ionization mode. When using CBS, this issue can be reduced or avoided by employing a post-extraction washing step with water to remove salts from the sample and a meniscus-shaped blade tip, which can decrease the onset voltage of the ESI spray. When these measures are employed, corona discharge does not occur during the ionization process. Nonetheless, the overall RSD % is still high, even with tedious operations like removing bubbles from the desorption solution and wetting the metal tip with solvent.

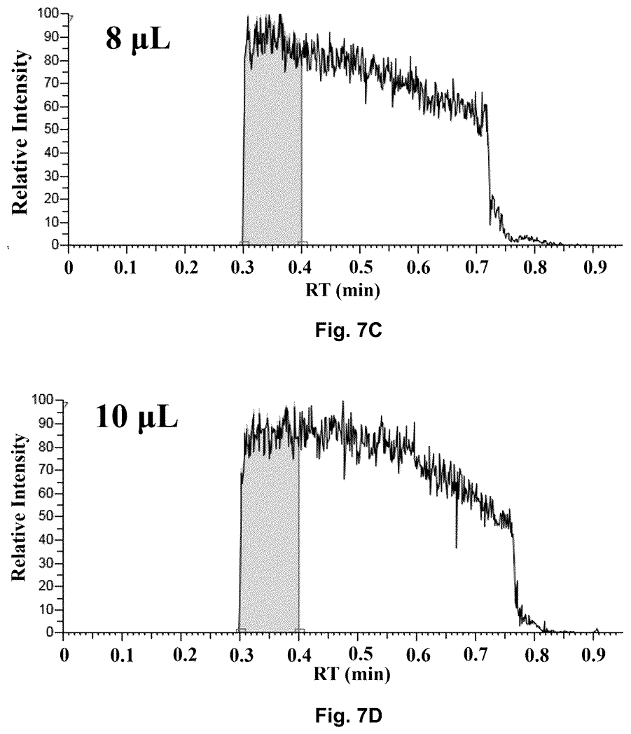

To address the above issues, three different strategies were compared: normal horizontal spray after wetting the blade tip and removing bubbles generated during the addition of desorption solution with a pipette (“flat”), tilting the blade to 20 degrees (“tilt”), and using a device according to the present disclosure (“barrier”) in a horizontal orientation. The results for the peak areas and RSD % were shown in Table 2 and Table 3. The peak area of the CBS-with-barrier method had a much lower overall RSD %, with RSD % for the three targeted compounds of less than 10%, while both normal CBS operation and tilting the blade show RSD % around 30%. The results also showed that all three strategies showed good RSD % (<10%) when calculated with the spiked internal standards. No significant difference in the raw peak areas of the three strategies was observed. FIG. 5 shows the typical spectrogram for the CBS-with-barrier method wherein the device was positioned flat and subjected to a stable spray with a flat MS spectrum signal for 6 s. The peak area in this 6 s time frame was always used for quantitative calculation.

TABLE 2
Comparison of three strategies of CBS-MS in negative
ionization mode; each RSD % has eight replicates.

| | | | | Flat | Tilt | Barrier |
|---|---|---|---|---|---|---|
| Compound | Flat | Tilt | Barrier | (with IS) | with IS) | (with IS) |
| Dexamethasone | 29% | 30% | 8% | 4% | 7% | 2% |
| Prednisone | 29% | 29% | 8% | 1% | 2% | 1% |
| Budesonide | 27% | 32% | 7% | 0% | 2% | 4% |

TABLE 3
Comparison of three strategies of
CBS-MS in negative ionization
mode; Peak area (*10⁵)

| Compound | Flat | Tilt | Barrier |
|---|---|---|---|
| Dexamethasone | 55 | 58.3 | 62.5 |
| Prednisone | 3.6 | 3.7 | 3.9 |
| Budesonide | 1.4 | 1.6 | 1.5 |

Cone-jet mode is the most popular ESI mode, as it explains the transfer of analytes from the condensed phase to the gas phase. In this mode, the ESI is divided into three processes: (1) the formation of a stable spray, (2) droplet evolution, and (3) formation of gas-phase ions. After applying a high voltage, the electric field penetrates the liquid surface and creates a meniscus at the blade tip. The charged ions concentrate near the surface of the meniscus, causing it to become destabilized and distorted and leading to the formation of a Taylor cone. When the applied voltage is high enough, the electric pressure drives a jet from the cone apex. The required threshold voltage (onset voltage, Vₒₙ) can be estimated using the following equation:

$${V}_{on} = 2 \times 1 {0}^{5} {( γ {r}_{c} )}^{1 / 2} ln ( \frac{4 d}{{r}_{c}} )$$

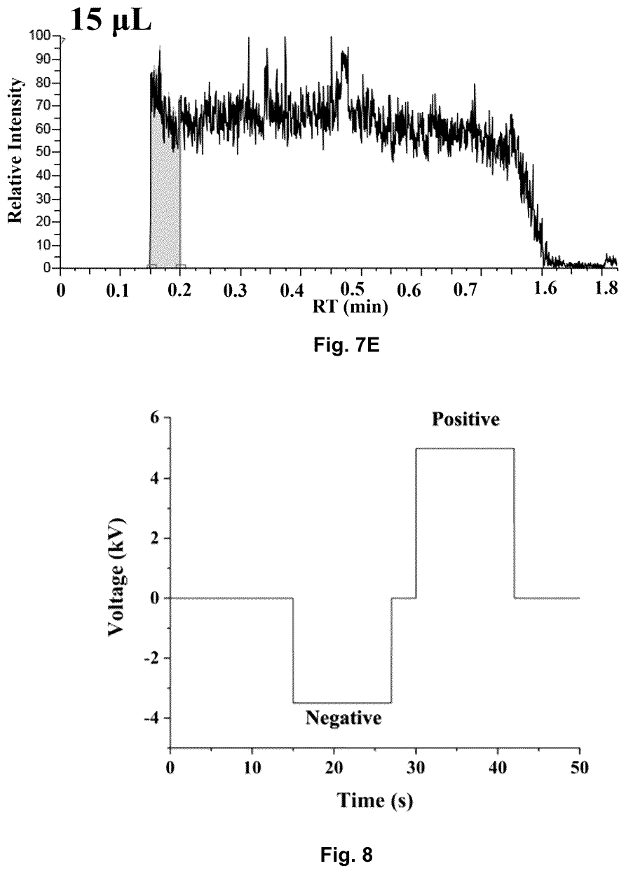

In this equation, Vₒₙ depends on the tip's outer radius r_{c}, the surface tension of the spray solvents y, and the distance between the tip and MS counter. The emitter shape and the material type can also influence the Vₒₙ. According to previous studies, when the applied voltage (V) is higher than Vₒₙ, the required flow rate increases alongside the applied voltage. However, the beveled or meniscus tip is able to provide a more stable ESI spray with a lower Vₒₙ at a lower flow rate. Therefore, the tip geometry in the new generation of the CBS blades (FIG. 6) has evolved from a flat shape to a meniscus shape, which can reduce the onset voltage and the requirement of the flow rate to maintain a stable spray. To better understand the differences between CBS with and without a barrier, the Taylor cones generated by both devices were monitored using a microscope camera equipped with a laser. In particular, this analysis focused on the formation of a stable spray process, which could be the main difference between CBS with and without a barrier. Videos were obtained and some of the important time points were captured as screenshots and shown in FIG. 6.

In positive ionization mode, the Taylor tip and jet were close to the stainless-steel tip, while in negative mode, the liquid cone was much longer, and the jet was further away from the tip. This phenomenon was due to the Taylor cone's propensity to decrease as the applied voltage increases. The optimized voltage in positive ionization mode was 5 kV, which is much higher than the optimized voltage in negative mode (−3.8 kV). The use of higher voltages in negative mode results in unstable spray and corona discharge, as well as higher electronic pressure and flow rates.

As shown in FIG. 6, CBS both with and without a barrier generated a stable ESI spray for at least 30 s with 8 μL of desorption solution (MeOH/water 95:5+0.1% FA) in positive mode; this result is consistent with the MS signal the authors of the present disclosure received, which confirms that CBS can generate a stable signal in positive ionization mode. However, since the applied voltage is lower in negative ionization mode, the electronic pressure at the tip generated by the ESI is also lower. For the CBS device without a barrier, the Taylor cone began to vibrate and become unstable in a horizontal direction after 9 s. As can be seen in FIG. 6, the addition of the barrier enabled the stability of the Taylor cone for more than 40 s. This phenomenon was also correlated to the MS signal received during the experiment. Furthermore, the movement of the desorption solvent on the blade was also monitored to gain a better understanding of the above results. The solvent located away from the tip on the device with no barrier did not constantly flow to the tip during the spraying process. After several seconds, the liquid began to divide into two segments and, finally, three segments. In contrast, the addition of a barrier restricted the movement of the desorption solvent on the blade, causing it to form a wedge-shaped pattern. Due to gravity and surface tension effects, the liquid can continually compensate for the spray liquid being removed from around the tip. Without wishing to be bound by theory, the authors of the present disclosure believe that the improvement of the stability in negative ionization mode was that without a barrier, because of the lower applied voltage, the electronic force on the liquid meniscus was lower, which limited the stability in negative ionization mode and cannot keep the stable spray for a long time. Conversely, the wedge-shaped liquid formation created by the barrier on the blade can provide a force toward the blade tip by gravity—along with electronic force—providing the force required to drive the solvents to the tip, thus generating a stable ESI spray that keeps running for a longer time.

Two additional points must also be emphasized. First, as shown in FIG. 6, without the barrier, the desorption solvent leaked away from the coating to the holding end of the CBS blade, which changed the effective desorption volume and resulted in low reproducibility. However, the addition of a barrier to the end of the coating helped to prevent the loss of desorption solution, which means that the effective volume of desorption solution could be the same. Second, during the ESI process, the authors of the present disclosure noticed that some of the desorption solution was leaking to the opposite side of the blade. Although this leakage could influence the RSD % of the results, the quantitative data presented in Table 2 show that the RSD % of the CBS-MS was still less than 10%. These results may be due to the concentration of analytes in the solvent reaching a constant level after a certain desorption time, which means that the solvent leaking to the other side during spraying would not impact the concentration of analytes in the spray solvent. Nonetheless, this leakage could be addressed by using less desorption solution, extending the barrier to surround the coating fully (as illustrated in the device of FIG. 3) or fabricating a CBS device that has an indentation or curve in the blade where the extraction phase is placed.

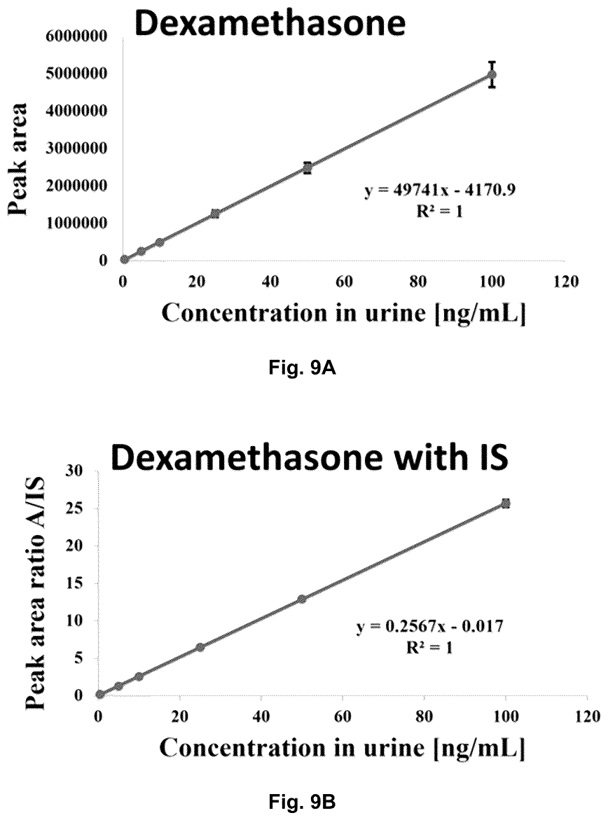

Additional advantages of CBS with a Barrier. Besides higher ESI spray stability in negative mode, other advantages of installing a barrier on the blade were explored. As shown in FIG. 6, the duration of stable ESI spray in negative ionization mode using CBS with a barrier was longer than the CBS without a barrier when adding the same desorption solvent. In addition, as mentioned above, the barrier can prevent the leakage of the desorption solvent from the coating end (i.e. the spray-ionization end) to the far end of the blade (i.e. the holding end), thus making the desorption process more controllable. As shown in Table 4, different volumes of desorption solvent (3 to 15 μL) were applied to the blade after extraction. No stable signal was attained when 3 μL was applied to the blade, and the peak area decreased alongside the volume from 5 to 15 μL. This latter result was due to the concentration decreasing as the desorption volume increased. The RSD % for the application of 15 μL was a little bit higher, which may be due to the desorption solvent leaking to the opposite side of the blade. Nonetheless, this RSD % was still acceptable. The volume of desorption solution not only influences the sensitivity, but it also influenced the MS detection window. As shown in FIGS. 7A to 7E, the detection window increased alongside the volume of desorption solvent. For the quantitative analysis of the target compounds via the MRM method, more MS transitions can be detected by increasing the length of the detection window while keeping the dwell time of each transition the same. However, when using the CBS blade without a barrier, a large amount of desorption solvent tends to leak from the coating material to the stainless-steel portion of the blade, which influences both the desorption and ionization processes. The CBS blade with a barrier enables the use of different volumes of desorption solution, which allows users to find the optimal balance between sensitivity and detection window based on their specific application. Likewise, the distance between the barrier and the tip can also be adjusted for similar purposes. As shown in Table 5, the sensitivity of the CBS method changes with the application of 8 μL of desorption solvent, with the highest sensitivity being obtained 6 mm from the tip. Of course, the distance between the barrier and the tip and the amount of desorption solution are related and influence the sensitivity (i.e., signal intensity) and detection window (i.e., stable spray time). Thus, the CBS-blade-with barrier design gives users more options regarding these two parameters.

TABLE 4
The peak area (*10⁵) and RSD % with different
volume of desorption solvents in negative ionization
mode (each RSD % has 4 replicates).

| Compound | 5 μL | | 8 μL | | 10 μL | | 15 μL | |
|---|---|---|---|---|---|---|---|---|
| Dexamethasone | 10% | 172.7 | 10% | 148.3 | 11% | 137.1 | 14% | 80.0 |
| Prednisone | 12% | 11.0 | 10% | 9.2 | 9% | 8.5 | 15% | 4.8 |
| Budesonide | 8% | 6.4 | 10% | 5.7 | 7% | 5.1 | 11% | 3.2 |

TABLE 5
Peak area (*10⁵) with barriers at
different distances from spray-ionization tip

| Compound | 8 mm | 6 mm | 4 mm |
|---|---|---|---|
| Dexamethasone | 85.9 | 124.1 | 76.1 |
| Prednisone | 5.5 | 7.7 | 4.7 |
| Budesonide | 3.3 | 4.3 | 2.7 |

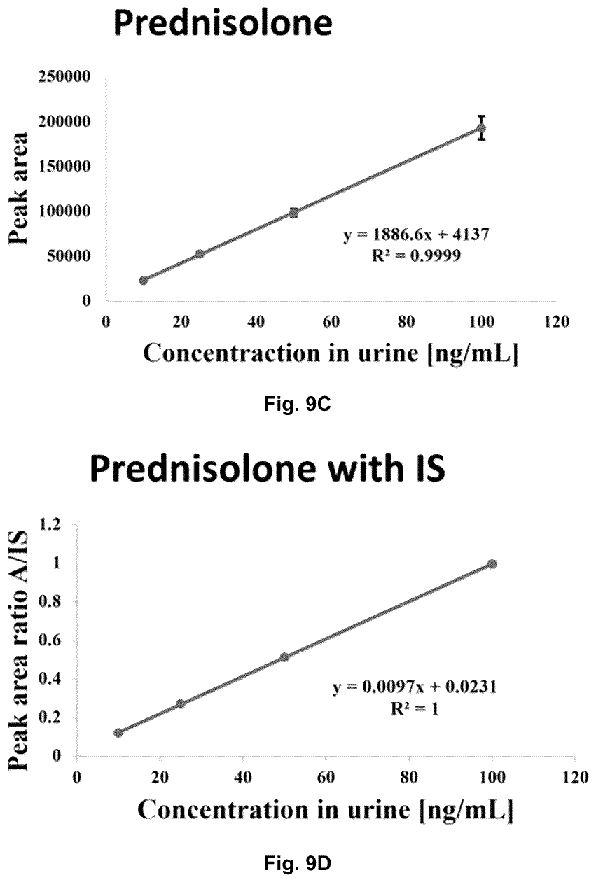

The long detection window of the CBS-with-barrier design allows the spray to be divided into two segments via both positive and negative ionization in the same analytical run. MeOH/water 95:5+2.5 mM NH₄F+2.5 mM NH₄HCOO were selected as the desorption and ionization solvents, respectively, as previous experience has suggested that negative ionization has a higher requirement than positive ionization regarding the solvents. This method and result are shown in FIG. 8 and Table 6. As can be seen, the raw peak areas were stable in both negative and positive ionization modes, with an RSD % of less than 10% in negative mode and less than 15% in positive mode (n=4). Similarly, the RSD % of the peak area ratio of the analytes to internal standards was less than 7% in negative mode and less than 11% in positive mode.

TABLE 6
The results for analysis compounds using negative
and positive ionization modes by one blade.

| | | | RSD | RSD (with IS) |
|---|---|---|---|---|
| Compounds | Mode | Peak area | (n = 4) | (n = 4) |
| Dexamethasone | Negative | 9.555*10⁴ | 10% | 7% |
| Prednisolone | Negative | 1.433*10⁶ | 8% | 2% |
| Budesonide | Negative | 8.449*10⁴ | 10% | 3% |
| Amphetamine | Positive | 5.540*10⁶ | 7% | 2% |
| Atenolol | Positive | 4.657*10⁶ | 9% | 11% |
| Clenbuterol | Positive | 1.443*10⁷ | 12% | 1% |
| Diazepam | Positive | 9.388*10⁶ | 13% | 2% |
| Fentanyl | Positive | 1.336*10⁷ | 12% | 1% |
| Nikethamide | Positive | 2.289*10⁷ | 15% | 5% |
| Nordiazepam | Positive | 5.711*10⁶ | 15% | 2% |
| Propranolol | Positive | 5.778*10⁶ | 15% | 3% |

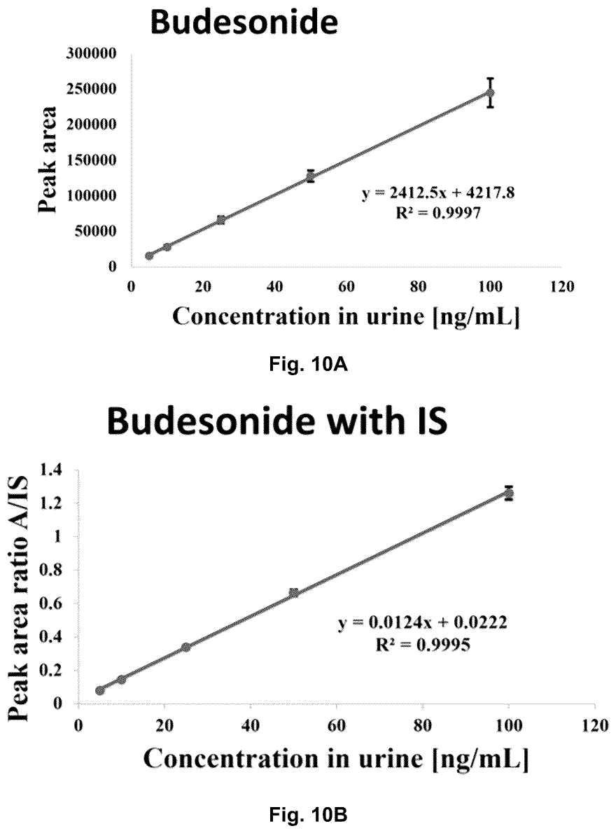

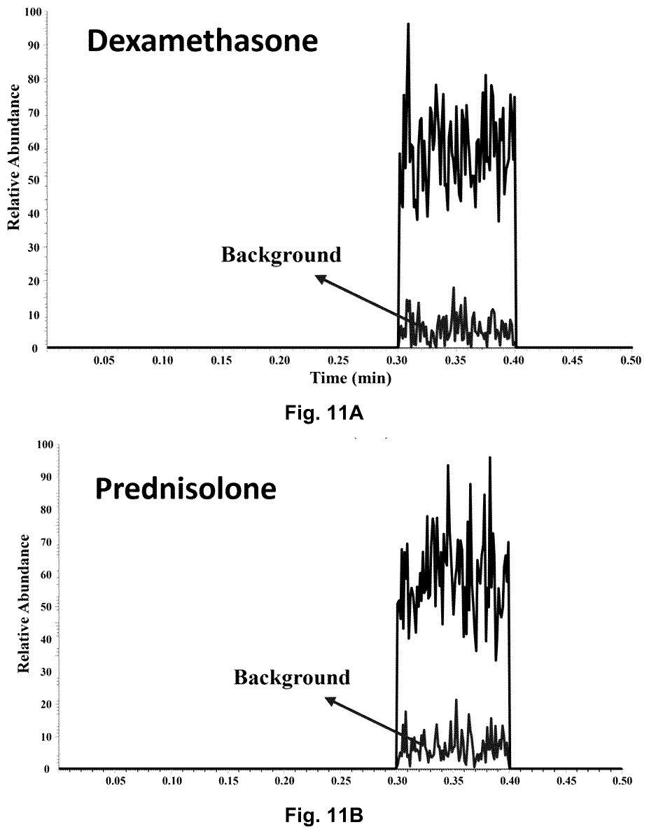

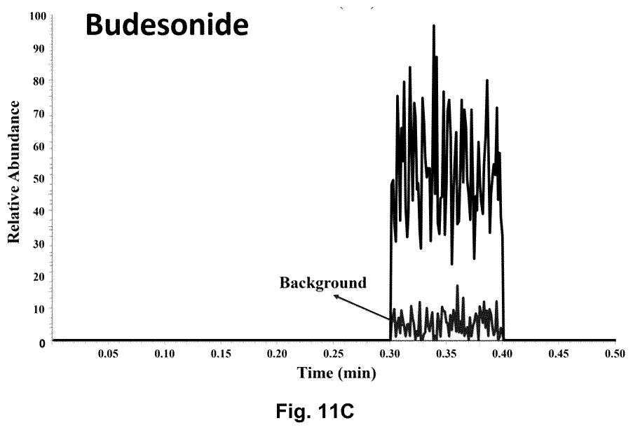

Quantitative Analysis of Three Drugs of Abuse in Urine with Negative Ionization by Automated and High-Throughput SPME. The CBS blade with a barrier was used with a Concept-96 blade extraction system to enable the automated analysis of three drugs of abuse (i.e., dexamethasone, budesonide, and prednisolone) in human urine samples. Prednisolone-¹³C₃ was used as an internal standard for the three analytes and was spiked into the urine samples before testing. As shown in FIGS. 9A to 9D, 10A and 10B, even without calculation using the internal standard, the calibration curves for the three compounds still exhibited very good linearity with correlation coefficients (R²) larger than 0.9997. This result was comparable with the R² obtained using the peak area-to-IS ratio. Indeed, the obtained results are incredible when compared with other ambient MS techniques. The RSD % for all calibration points (n=6) was lower than 11%, and the LOQs for dexamethasone, budesonide, and prednisolone were 0.5, 5, and 10 ng/mL, respectively. The spectrograms for these three compounds at the LOQ concentration level are shown in FIGS. 11A to 11C, which also indicates a very stable MS signal.

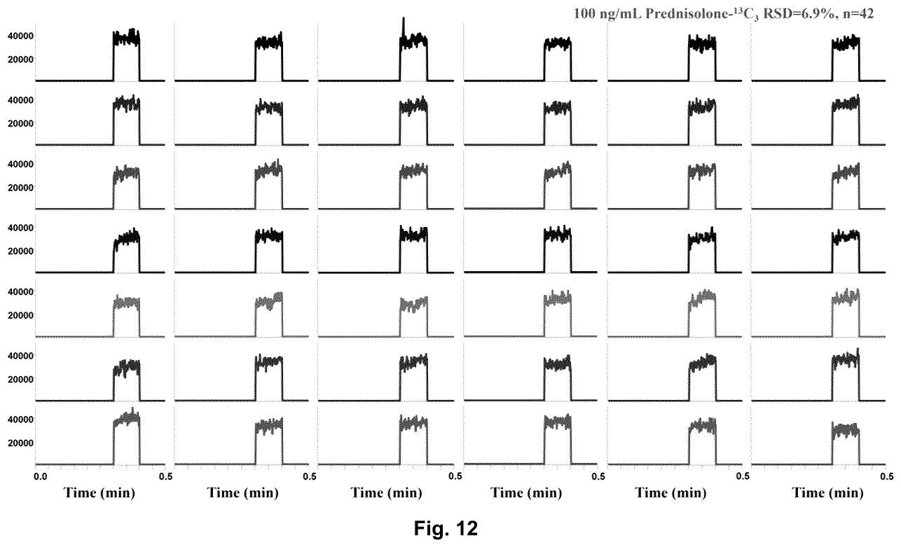

A total of 42 samples (seven calibration curve points with six replicates at every point) spiked with the same concentration of prednisolone-¹³C₃ as an internal standard were used to construct the calibration curves. As shown in FIG. 12, the 42 spectrograms of prednisolone-¹³C₃ all had good peak shapes, with an overall peak area RSD % of 6.9%. The above data demonstrates the CBS-with-barrier method's excellent reproducibility and ability to produce good calibration curves for quantitative analysis.

Performance in Positive Ionization Mode and One Drop of Plasma Analysis with the On-Blade Extraction Method. The CBS-with-barrier design's performance in positive ionization mode was also tested. Table 7 shows the RSD % (n=8) and peak raw area-to-IS ratios calculated after the extraction of the 14 drugs of abuse in PBS solution and detection in positive ionization mode. Compared to the CBS without a barrier, the raw peak area obtained with the CBS-with-barrier method showed better reproducibility, which may be due to its ability to minimize the leakage of desorption solvent. After calculation with an IS, these two methods showed good reproducibility, with most of the obtained RSD % being less than 10%. Interestingly, the CBS blade-with-barrier design showed even better reproducibility in negative ionization mode than in positive ionization mode.

TABLE 7

| | | Without barrier (n = 8) | | | With barrier (n = 8) | | |
|---|---|---|---|---|---|---|---|
| | | Peak | | RSD | Peak | | RSD |
| Compounds | Mode | area | RSD | (with IS) | area | RSD | (with IS) |
| Amphetamine | Positive | 1.377*10⁷ | 14% | 1% | 8.643*10⁶ | 14% | 1% |
| Atenolol | Positive | 4.523*10⁶ | 18% | 12% | 3.230*10⁶ | 13% | 6% |
| Buprenorphine | Positive | 1.506*10⁶ | 19% | 2% | 1.235*10⁶ | 12% | 1% |
| Carbamazepine | Positive | 1.270*10⁷ | 31% | 1% | 1.453*10⁷ | 18% | 0% |
| Clenbuterol | Positive | 4.409*10⁷ | 15% | 1% | 3.901*10⁷ | 9% | 1% |
| Cocaine | Positive | 1.203*10⁸ | 14% | 1% | 1.088*10⁸ | 10% | 1% |
| Codeine | Positive | 4.158*10⁶ | 18% | 1% | 3.222*10⁶ | 14% | 1% |
| Diazepam | Positive | 3.705*10⁷ | 29% | 3% | 4.344*10⁷ | 15% | 2% |
| Fentanyl | Positive | 1.373*10⁸ | 16% | 0% | 1.035*10⁸ | 12% | 0% |
| Morphine | Positive | 2.422*10⁶ | 21% | 4% | 2.124*10⁶ | 12% | 2% |
| Nordiazepam | Positive | 2.817*10⁷ | 27% | 1% | 3.408*10⁷ | 14% | 1% |
| Propranolol | Positive | 3.344*10⁷ | 14% | 1% | 2.779*10⁷ | 11% | 1% |
| Strychnine | Positive | 6.472*10⁶ | 15% | 3% | 4.945*10⁶ | 15% | 1% |

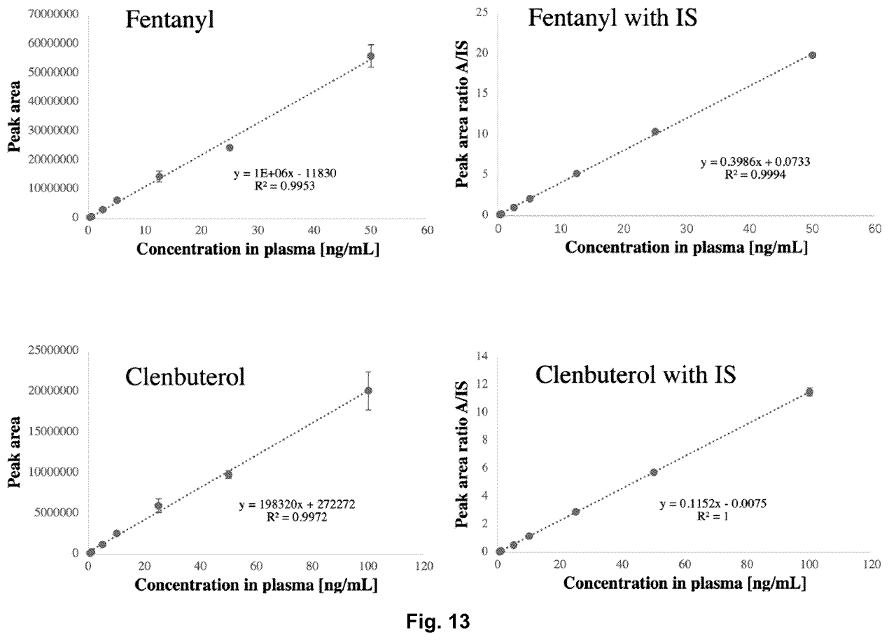

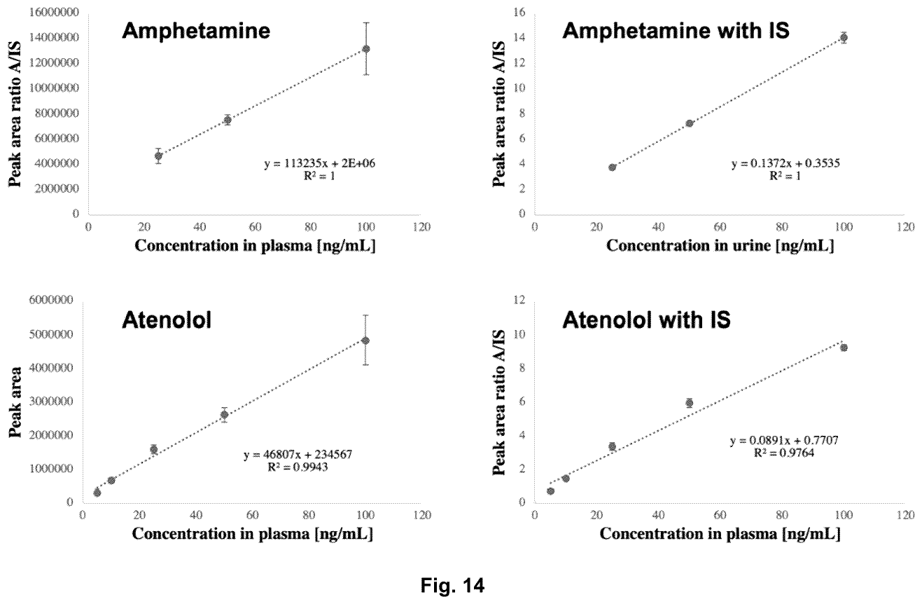

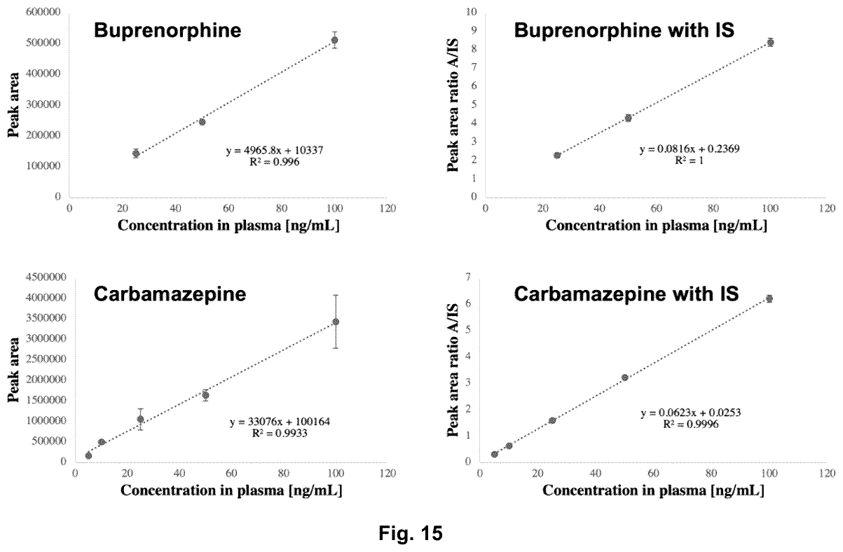

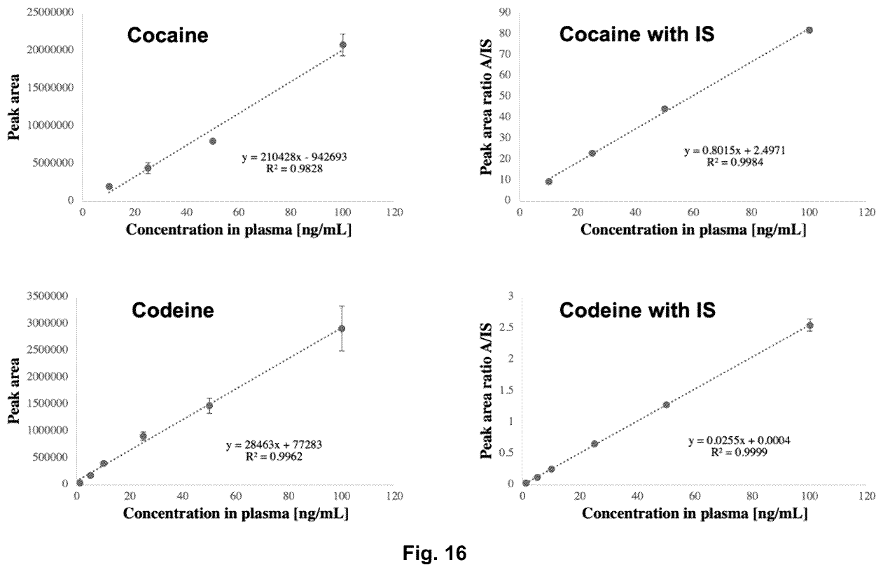

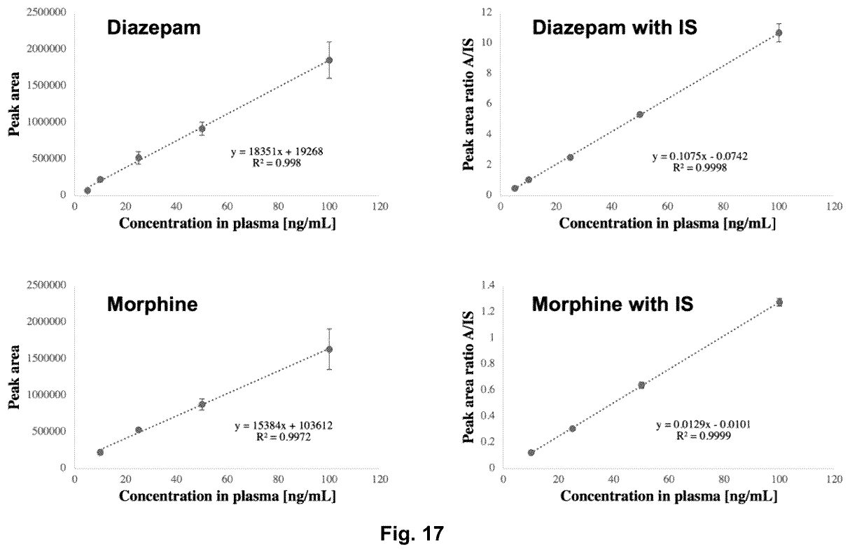

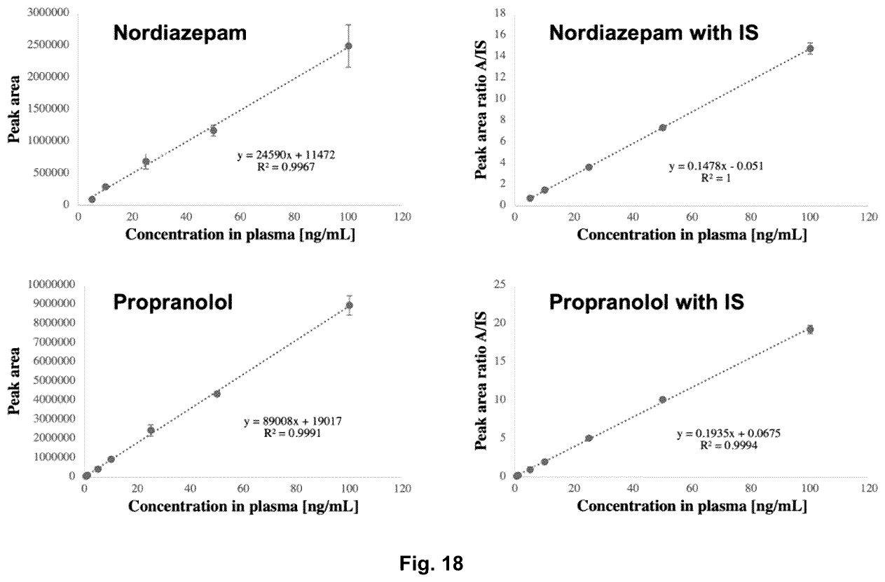

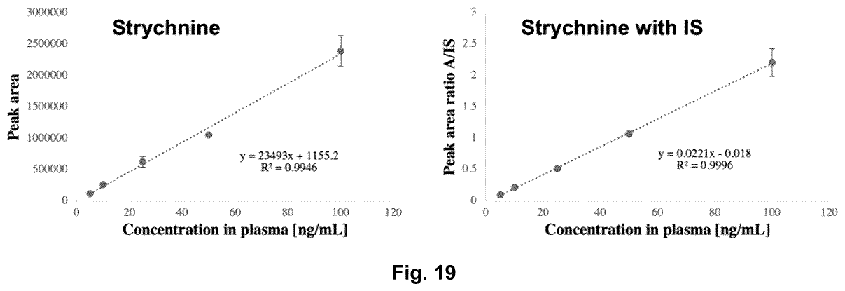

The analysis of one drop of plasma analysis can be achieved via on-blade extraction, wherein a small amount (5 to 20 μL) of sample is directly applied to the CBS blade coating for extraction. This technique, known as “extracted blood spot” (EBS), has been proposed by Gômez-Rios et al. in “Quantitative analysis of biofluid spots by coated blade spray mass spectrometry, a new approach to rapid screening.” Sci Rep 7, 16104 (2017) to address the issues of high matrix effects and low sensitivity associated with the standard blood spot analysis used for antidoping tests. Based on the above advantages, the CBS-with-barrier design can also be used to prevent sample leakage during the on-blade extraction process. In this case, the CBS device with a barrier was applied for on-blade extraction from 20 μL of plasma samples. The calibration curve results with and without calculation using ISs were tested; the results of these tests are provided in FIGS. 13 to 19 and Table 8. As can be seen, satisfactory correlation coefficients (R²≥0.9828) were obtained without the use of ISs. The correlation coefficient calculated with ISs was R² was ≥0.9984, with the exception of atenolol, which had an R² of 0.9764. The lower correlation coefficient for atenolol may have been due to the use of metoprolol as an IS, as the present authors were unable to obtain an isolable IS for this compound. The above results demonstrate the coated-blade-with-barrier design's suitability for the analysis of small amounts of the sample via on-blade extraction.

TABLE 8

| | | | | Slope | | R² | LOQ | LOD | Linearity |
|---|---|---|---|---|---|---|---|---|---|
| | | | | (with | Intercept | (with | (ng/ | (ng/ | range |
| Compounds | Slope | intercept | R² | IS) | (with IS) | IS) | mL) | mL) | (ng/mL) |
| amphetamine | 1.132 × 10⁵ | 1.852 × 10⁶ | 1.0000 | 0.1372 | 0.3535 | 1.0000 | 25 | 8 | 25 to 100 |
| atenolol | 4.680 × 10⁴ | 2.346 × 10⁵ | 0.9943 | 0.0891 | 0.7707 | 0.9764 | 5 | 2 | 5 to 100 |
| buprenorphine | 4.966 × 10³ | 1.034 × 10⁴ | 0.996 | 0.0816 | 0.2369 | 1.000 | 25 | 5 | 25 to 100 |
| carbamazepine | 3.308 × 10⁴ | 1.002 × 10⁵ | 0.9933 | 0.0623 | 0.0253 | 0.9996 | 5 | 1 | 5 to 100 |
| clenbuterol | 1.983 × 10⁵ | 2.723 × 10⁵ | 0.9972 | 0.1152 | −0.0075 | 1.0000 | 0.5 | 0.2 | 0.5 to 100 |
| cocaine | 2.104 × 10⁵ | −9.427 × 10⁵ | 0.9828 | 0.8015 | 2.4971 | 0.9984 | 10 | 2 | 10 to 100 |
| codeine | 2.846 × 10⁴ | 7.728 × 10⁴ | 0.9962 | 0.0255 | 0.0004 | 0.9999 | 1 | 0.3 | 1 to 100 |
| diazepam | 1.835 × 10⁴ | 1.927 × 10⁴ | 0.998 | 0.1075 | −0.0742 | 0.9998 | 5 | 1 | 5 to 100 |
| fentanyl | 1.094 × 10⁶ | −1.183 × 10⁴ | 0.9953 | 0.3986 | 0.0733 | 0.9994 | 0.25 | 0.02 | 0.25 to 100 |
| morphine | 1.538 × 10⁴ | 1.036 × 10⁵ | 0.9972 | 0.0129 | −0.0101 | 0.9999 | 10 | 3 | 10 to 100 |
| mordiazepam | 2.459 × 10⁴ | 1.147 × 10⁴ | 0.9967 | 0.1478 | −0.051 | 1.0000 | 5 | 1 | 5 to 100 |
| propranolol | 8.901 × 10⁴ | 1.902 × 10⁴ | 0.9991 | 0.1935 | 0.0675 | 0.9994 | 0.5 | 0.2 | 0.5 to 100 |
| strychnine | 2.349 × 10⁴ | 1.115 × 10³ | 0.9946 | 0.0221 | −0.018 | 0.9996 | 5 | 1 | 5 to 100 |

In summary, the exemplary devices showed significantly increased stability of ESI in negative ionization mode. The ESI spray in both positive and negative modes was investigated by observing the spray process using a microscope camera and analyzing a selection of target compounds via MS. The obtained results were well correlated to each other and confirmed that the introduction of the barrier was responsible for the stable ESI spray in negative ionization. Without wishing to be bound by theory, the authors of the present disclosure believe that the wedge-shaped liquid formation on the blade created by the barrier, gravity, and surface tension effects, forced the solvent to the tip of the device, along with the electronic pressure, generating a stable ESI spray.

The results associated with these exemplary devices also suggested that the barrier can prevent the leakage of the desorption solution from the coating material, thereby making the whole desorption process more controllable and/or more adjustable. The sensitivity and length of the MS detection window may be adjusted by the users based on the specific requirements of their application. Finally, the authors of the present disclosure tested the CBS-with-barrier design using two different sampling methods in positive and negative ionization modes: high-throughput analysis with an automated Concept-96 SPME system and on-blade sampling for the analysis of small amounts of the biological sample. Both CBS-MS methods returned excellent analytical results, even without correction with internal standards, which demonstrated the CBS-with-barrier method's reproducibility and the practicability of the two sampling methods.

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

1. A device for generating ionized molecules of interest for analysis in a mass spectrometer, wherein the molecules of interest are desorbed from the device into a desorption solvent, the device comprising:
a solid substrate having a spray-ionization end and a holding end, the substrate sized and configured to hold the solvent at the spray-ionization end; and
a fluid barrier configured to reduce movement of at least some of the solvent from the spray-ionization end towards the holding end.

2. The device according to claim 1, wherein the barrier is integral with the substrate.

3. The device according to claim 1, wherein:
the device further comprises a substrate holder configured to engage the holding end of the substrate,
the substrate holder comprises the barrier, and
the barrier abuts the substrate when the substrate holder engages the holding end of the substrate.

4. The device according to any one of claims 1 to 3, wherein the substrate is at least a two-sided substrate and the device comprises a fluid barrier on each side,
such as the device according to claim 3 wherein:
the substrate is at least a two-sided substrate,
the device comprises a substrate holder configured to engage the holding end of the substrate,
the substrate holder comprises a fluid barrier on each side, and
the fluid barriers abut the substrate when the substrate holder engages the holding end of the substrate.

5. The device according to any one of claims 1 to 4, wherein
the substrate and the barrier are configured and positioned to hold at least 5 μL of the solvent, such as from about 5 μL to about 15 μL of the solvent, between the spray-ionization end and the barrier;
the barrier extends at least about 0.5 mm above the surface of the substrate; and/or
the distance from the spray-ionization end to the barrier is from about 4 mm to about 10 mm.

6. The device according to any one of claims 1 to 5, wherein the barrier extends from one side edge to an opposite side edge, for example dividing the substrate into a holding portion and a spray-ionization portion.

7. The device according to any one of claims 1 to 6, wherein the barrier is configured to reduce movement of at least some of the solvent towards edges that are not for spray ionization, such as side edges.

8. The device according to any one of claims 1 to 7, wherein the device is configured to desorb the molecules of interest into the desorption solvent and generate the ionized molecules while the surface of the substrate is substantially horizontal.

9. The device according to any one of claims 1 to 8, wherein the barrier is surface-deactivated.

10. The device according to any one of claims 1 to 9, wherein:
the substrate is substantially flat or comprises an indentation or curve in the substrate to direct the desorption liquid along the longitudinal axis of the substrate;
the substrate is at least one of a metal, a metal alloy, and a polymer, preferably previously etched stainless-steel;
the substrate is surface-deactivated;
the spray-ionization end comprises a tip having a substantially triangular shape and being defined by at least two edges that meet at an angle from about 8 degrees to about 90 degrees;
the substrate has an average thickness that is from about 0.01 mm to about 2 mm;
the substrate has a length from about 1 cm to about 10 cm;
the substrate has a width from about 0.1 to about 5 mm;
the device comprises an extractive phase coating, such as a solid phase microextraction (SPME) coating, on at least a portion of the surface between the spray-ionization end and the barrier, and optionally comprises a sealing layer between the extractive phase coating and the substrate, preferably wherein the sealing layer lacks any extractive phase material;
the substrate has a non-uniform thickness such that the spray-ionization end has a smaller thickness relative to the rest of substrate, the non-uniform thickness creating a slope to lead by gravity the solvent containing the molecules of interest towards the spray-ionization end;
the desorption solvent comprises at least one of methanol, acetonitrile and water; and/or
the device is configured to generate spray in a negative ionization mode.

11. A method for analyzing molecules previously extracted from a sample and adsorbed onto a solid substrate, the substrate comprising a spray-ionization end, a holding end, a fluid barrier between the spray-ionization end and the holding end, wherein the extracted molecules are adsorbed on an extraction portion of the substrate between the fluid barrier and the spray-ionization end, the method comprising:
holding the substrate in a substantially horizontal orientation, such as an orientation with an absolute pitch angle of less than 15°, such as less than 10°, less than 5° or about 0°;
applying a desorption solvent to the substrate, for example applying from about 5 μL to about 15 μL of the solvent;
desorbing molecules from the substrate;
ionizing the desorbed molecules using an ionization source to expel ionized molecules from the spray-ionization end of the substrate; and
analyzing the formed ions by mass spectrometry,
wherein the fluid barrier is configured to reduce movement of at least some of the desorption solvent from the spray-ionization end to the holding end.

12. The method according to claim 11, wherein the barrier is integral with the substrate.

13. The method according to claim 11, wherein:
the method comprises holding the substrate with a substrate holder, and
holding the substrate with the substrate holder forms the fluid barrier.

14. The method according to any one of claims 11 to 13, wherein the ionization is negative ionization and/or wherein the mass spectrometry is electrospray ionization.

15. The method according to any one of claims 11 to 14, wherein the extraction portion of the substrate is substantially flat and the method comprises holding the substrate in an orientation with the extraction portion having an absolute bank angle of less than 15°, such as less than 10°, less than 5° or about 0°.

16. The method according to any one of claims 11 to 15, wherein:
the substrate comprises at least two sides,
the substrate comprises a fluid barrier on the second side between the spray-ionization end and the holding end,
additional extracted molecules are adsorbed on a second extraction portion of the substrate between the fluid barrier and the spray-ionization end,
and the method further comprises:
removing the desorption solvent from the solid substrate,
repositioning the solid substrate to present the second side of the substrate in a substantially horizontal orientation, such as an orientation with an absolute pitch angle of less than 15°, such as less than 10°, less than 5° or about 0°;
applying a desorption solvent to the second side of the solid substrate;
desorbing molecules from the second side of the solid substrate;
ionizing the desorbed molecules using an ionization source to expel ionized molecules from the spray-ionization end of the solid substrate; and
analyzing the formed ions by mass spectrometry.

17. A method for analyzing molecules previously extracted from a sample onto a device according to any one of claims 1 to 10, the method comprises:
holding the substrate in a substantially horizontal orientation, such as an orientation with an absolute pitch angle of less than 15°, such as less than 10°, less than 5° or about 0°;
applying a desorption solvent to device, for example applying from about 5 μL to about 15 μL of the solvent;
desorbing molecules from the device;
ionizing the desorbed molecules using an ionization source to expel ionized molecules from the spray-ionization end of the substrate; and
analyzing the formed ions by mass spectrometry.

18. A method for analyzing molecules in a sample, the method comprising:
holding a solid substrate in a substantially horizontal orientation, such as an orientation with an absolute pitch angle of less than 15°, such as less than 10°, less than 5° or about 0°, wherein the substrate comprises a spray-ionization end, a holding end, a fluid barrier between the spray-ionization end and the holding end, and a sorption portion between the fluid barrier and the spray-ionization end;
applying a sample solution to the sorption portion of the substrate, for example applying from about 5 μL to about 15 μL of the sample solution;
removing the sample solution from the substrate to provide a solid substrate having molecules from the sample solution adsorbed thereon; and
performing the method according to any one of claims 11 to 16.

19. A method for analyzing molecules in a sample, the method comprising:
extracting molecules of interest from a sample onto a solid substrate, such as through solid phase microextraction (SPME), wherein the substrate comprises a spray-ionization end, a holding end, and a sorption portion;
holding the substrate with a substrate holder configured to engage the holding end of the substrate, wherein holding the substrate with the substrate holder provides a fluid barrier between the spray-ionization end and the holding end, wherein the substrate is held in a substantially horizontal orientation, such as an orientation with an absolute pitch angle of less than 15°, such as less than 10°, less than 5° or about 0;
applying a desorption solvent to device, for example applying from about 5 μL to about 15 μL of the solvent;
desorbing molecules from the device;
ionizing the desorbed molecules using an ionization source to expel ionized molecules from the spray-ionization end of the substrate; and
analyzing the formed ions by mass spectrometry.

20. A solid substrate for generating ionized molecules of interest for analysis in a mass spectrometer, the substrate configured to engage with a substrate holder, the substrate comprising:
a spray-ionization end and a holding end, the substrate sized and configured to hold solvent at the spray-ionization end,
wherein the substrate holder is configured to engage the holding end of the substrate and form a fluid barrier configured to reduce movement of at least some of the solvent from the spray-ionization end towards the holding end.
